(19) United States
(12) Patent Application Publication
(10) Pub. No.: US 2026/0270388 A1
(43) Pub. Date: Sep. 10, 2026

(54) Laser Light-Field Display with Controlled Angular Divergence for Reconstructing an Image with Horizontal or Full Parallax

(71) Applicants: Serhii Serhiienko, Newmarket on Fergus (IE); Maksym Serhiienko, Amsterdam (NL); Ievgen Sergiienko, Charlieville (IE); Olha Sergiienko, Charlieville (IE)

(72) Inventors: Serhii Serhiienko, Newmarket on Fergus (IE); Maksym Serhiienko, Amsterdam (NL); Ievgen Sergiienko, Charleville (IE); Olha Sergiienko, Charleville (IE)

(21) Appl. No.: 19/657,875

(22) Filed: Apr. 24, 2026

Related U.S. Application Data
(60) Provisional application No. 63/857,663, filed on Aug. 5, 2025.

(51) Int. Cl. H04N 13/398; H04N 13/32; H04N 13/351

(52) U.S. Cl. CPC H04N 13/398; H04N 13/32; H04N 13/351

(57) ABSTRACT

A light-field display is disclosed that includes a plurality of laser emitters arranged as display pixels, beam-shaping optics configured to form output beams having predetermined angular intensity distributions, an angular scanning subsystem, an angle sensing subsystem, and a controller. The controller independently modulates intensity of the laser emitters in synchronism with a current angular position and according to view data corresponding to that angular position, thereby reconstructing a light field observable from different viewer positions. In some embodiments, azimuthal divergence of the output beam is smaller than meridional divergence. In some embodiments, the angular scanning subsystem includes deflecting elements or rotatable laser-carrying elements, including cylinders, spherical elements, or vertical rotating screen elements. In some embodiments, a modulation node is provided for forming multiple meridional views. In some embodiments, a beam-direction detector is used for calibration. In some embodiments, active emitters are selected adaptively for inclined emission directions.

### CROSS-REFERENCE TO RELATED APPLICATIONS

This application claims the benefit under 35 U.S.C. § 119(e) of U.S. Provisional Patent Application No. 63/857,663, filed Aug. 5, 2025, the entire contents of which are incorporated herein by reference.

### FIELD

The present disclosure relates generally to display systems and, more particularly, to light-field and multiview display systems configured to present images observable from multiple viewer positions. In some embodiments, the disclosure relates to display systems providing horizontal parallax and/or full parallax. In further embodiments, the disclosure relates to systems employing laser light sources, beam-shaping optics, angular scanning of emitted light, and synchronized modulation of emitter intensity.

### BACKGROUND

Light-field and multiview displays may present images such that observers located at different positions relative to a display perceive different angular views of a scene. In known approaches, angular views may be formed using optical structures, such as lens arrays or prism arrays, spatial separation of emitters, beam scanning or steering mechanisms, or other techniques that distribute light in different directions.

For some applications, horizontal-parallax configurations are desirable, in which the perceived view changes primarily with horizontal movement of the observer. For other applications, full-parallax configurations are desirable, in which the perceived view changes with both horizontal and vertical movement of the observer.

In some existing multiview technologies, light sources and/or optical architectures exhibit non-negligible angular divergence such that adjacent views may partially overlap in angular space. Such overlap may reduce view separation and/or limit the effective number of distinguishable views within a given viewing range.

Additionally, some systems employ angular steering or scanning and synchronize brightness modulation with a current angular position. Practical implementations may be affected by mechanical tolerances, angle-to-view mapping inaccuracies, and individual pointing deviations among emitters, thereby motivating calibration and compensation.

Accordingly, there remains a need for improved techniques for generating light fields with multiple angular views, including for horizontal-parallax and full-parallax configurations, for example by combining controlled beam angular distributions, angular scanning, synchronized intensity modulation, and, in some embodiments, calibration and compensation.

### SUMMARY

A laser light-field display system is disclosed that includes a plurality of laser emitters arranged as display pixels, including, in some embodiments, RGB pixels, and beam-shaping optics configured to form output beams having predetermined angular intensity distributions.

The system includes an angular scanning subsystem configured to steer or scan the output beams through a plurality of azimuthal angular positions within an operational field of view, and an angle sensing subsystem configured to provide a current angular position, for example using an encoder or another sensing arrangement.

A controller independently modulates the intensity of the laser emitters in synchronism with the current angular position according to view data corresponding to the current angle, thereby reconstructing a light field observable from different viewer positions.

In some embodiments, each output beam is formed with azimuthal divergence smaller than meridional divergence. In some embodiments, the azimuthal divergence is characterized by a full width at half maximum (FWHM) of a far-field angular intensity profile, and the meridional divergence is selected to provide pixel visibility over a defined elevation viewing range.

In some embodiments, the angular scanning subsystem includes one or more deflecting elements. In some embodiments, the angular scanning subsystem includes laser-carrying elements mechanically coupled to a drive and configured to rotate about respective axes to steer the output beams.

In some embodiments, the laser-carrying elements include rotatable cylinders, each carrying a plurality of laser emitters and forming a vertical column of display pixels. In some embodiments, for at least one display pixel, red, green, and blue laser emitters are disposed at a common axial position on a cylinder and are angularly spaced about the cylinder.

In some embodiments, the laser-carrying elements include spherical elements arranged across a display surface, each spherical element carrying at least three laser emitters and being configured to steer output beams over a plurality of azimuthal and meridional angles.

In some embodiments, the laser-carrying elements include vertical rotating screen elements, each carrying more than one display pixel in a horizontal direction.

In some embodiments, the controller updates the view data when the angular position changes by an increment not greater than the azimuthal divergence defined by the FWHM of a far-field azimuthal intensity profile.

In some embodiments, the system further includes, for each display pixel, a modulation node configured to form multiple meridional views. In some embodiments, the modulation node includes an intensity modulator layer having independently controllable addressable regions.

In some embodiments, the system includes a beam-direction detector positioned outside the operational field of view for calibration. In some embodiments, the controller computes timing offsets and/or phase offsets for intensity modulation based on measurements obtained from the beam-direction detector.

In some embodiments, the operational field of view includes angular ranges on opposite sides of the display to enable viewing from both sides.

In some embodiments, when forming a view in a direction different from a direction substantially perpendicular to a plane of the display, the controller selects a subset of active laser emitters so as to reduce power consumption while maintaining required resolution.

### BRIEF DESCRIPTION OF THE DRAWINGS

FIG. 1A illustrates an example angular intensity distribution for a laser emitter 100 with beam-shaping optics 110 that form a beam narrow in azimuth and expanded in the meridional direction.

FIG. 1B illustrates an example angular intensity distribution for a laser emitter 100 with beam-shaping optics 120 providing comparatively low divergence in multiple cross-sections.

FIG. 2 illustrates an example scanning implementation including a laser emitter 100, beam-shaping optics 110, an angle-of-rotation sensor 160, a fixed mirror 161, and a movable mirror 162.

FIG. 3 illustrates a rotatable cylinder 150 carrying laser emitters 100 with beam-forming optics, an angle sensing arrangement, and a controller for laser-intensity control.

FIG. 4 illustrates a spherical pixel element 140 carrying RGB laser emitters 100 and configured for angular pointing over azimuth and elevation.

FIG. 5 illustrates a modulation-node embodiment including a rotatable cylinder 150 with laser emitters, modulators 170, a portion of a hemispherical surface without modulators, and a laser beam 180.

FIG. 6A illustrates a modulation-node embodiment including a rotatable cylinder 150 with lasers, laser beams 180 at different cylinder rotation angles, a positive optical element 200, a planar modulation structure 210, and a negative optical element 220.

FIG. 6B illustrates an example arrangement of modulators 170 on the modulation structure.

FIG. 7 illustrates an embodiment including laser emitters 100, vertical rotating screen elements 230, and a volumetric image 240 formed by the display.

### DEFINITIONS/MEASUREMENT CONVENTIONS

### Azimuthal Angle (phi)

“Azimuthal angle” refers to an angle in a scan plane used to provide horizontal view variation.

### Meridional Angle/Elevation Angle (theta)

“Meridional angle” or “elevation angle” refers to an angle in a plane orthogonal to the azimuthal scan plane and used to represent vertical viewing direction.

### Operational Field of View

“Operational field of view” refers to an angular range over which the system is configured to provide views by scanning or steering.

### Operational Viewing Zone

“Operational viewing zone” refers to an angular subset used for defining visibility and/or performance metrics.

### Far-Field Angular Intensity Profile

“Far-field angular intensity profile” refers to optical intensity as a function of angle, for example I(phi) in an azimuthal plane and I(theta) in a meridional plane, characterized under conditions corresponding to a far-field angular distribution.

### FWHM

FWHM is defined based on intensity.

### Azimuthal Divergence

“Azimuthal divergence” refers to angular beam width in an azimuthal plane, preferably characterized by azimuthal FWHM.

### Meridional Divergence

“Meridional divergence” refers to angular beam width in a meridional plane, preferably characterized by meridional FWHM.

### Addressable Region

An “addressable region” is an independently controlled region of an intensity modulator layer through which a portion of a beam passes.

### Diffraction-Induced Broadening

“Diffraction-induced broadening” refers to increased angular spread attributable to a finite dimension of an addressable region acting as an effective aperture.

### DETAILED DESCRIPTION

### 1. System Overview

In some embodiments, a light-field display system includes an array of laser emitters arranged as display pixels. For each laser emitter, beam-shaping optics form an output beam having a predetermined angular intensity distribution. An angular scanning subsystem scans output beams through multiple angular positions within an operational field of view. An angle sensing subsystem provides current angular position information to a controller. The controller independently modulates the optical output intensity of the emitters in synchronism with angle according to view data mapped to the current angle, thereby reconstructing a light field observable from multiple viewer positions.

### 2. Beam-Shaping Optics

In some embodiments, the beam-shaping optics form an output beam such that azimuthal divergence is smaller than meridional divergence. Such a configuration may be beneficial for horizontal-parallax systems because it reduces overlap between adjacent angular views in azimuth while maintaining visibility of a given pixel over a useful elevation range.

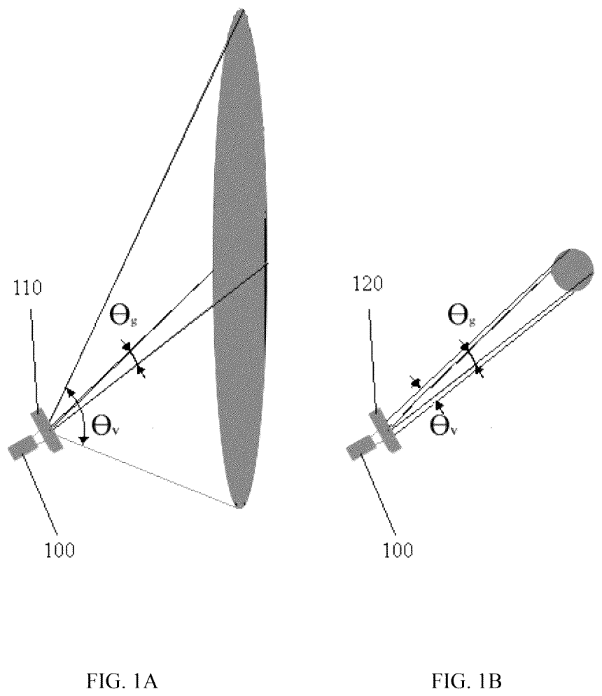

Beam-shaping optics may include one or more lens elements. In some embodiments, a lens element broadens the beam in a meridional direction relative to an azimuthal direction. In some embodiments, the optics may include cylindrical lenses, aspheric lenses, microlenses, Fresnel lenses, diffractive lenses, or combinations thereof. In one embodiment, such optics may be designated by numeral 110 and may form a beam that is narrow in azimuth and expanded in the meridional direction, as shown in FIG. 1A. In another embodiment, the optics may be designated by numeral 120 and may provide comparatively low divergence in multiple cross-sections, as shown in FIG. 1B.

### 3. Angular Scanning Subsystem

The angular scanning subsystem may be implemented in different ways. In one class of embodiments, one or more optical deflecting elements are used. In another class of embodiments, the system employs rotatable laser-carrying elements mechanically coupled to a drive and configured to rotate about respective axes such that emitted beams sweep through multiple angular directions.

### 4. Scanning-Module Embodiment

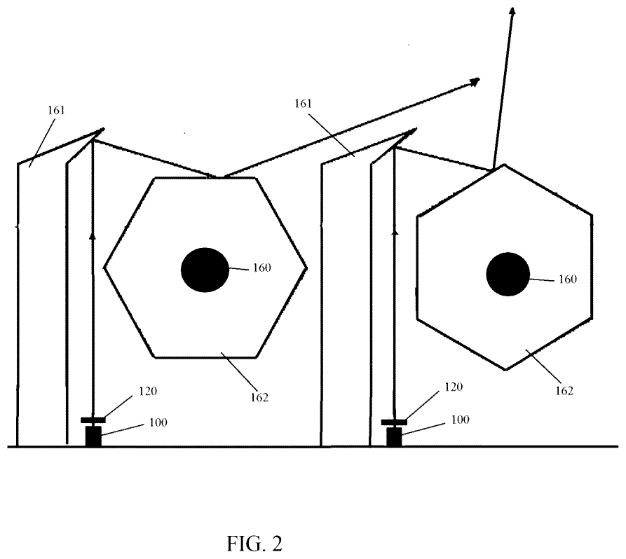

FIG. 2 illustrates an example implementation in which a laser emitter 100 and beam-shaping optics 110 direct emitted light toward a mirror arrangement including a fixed mirror 161 and a movable mirror 162. An angle-of-rotation sensor 160 provides a signal corresponding to a current scan angle, and a controller synchronizes intensity modulation with that signal.

### 5. Rotatable-Cylinder Embodiment

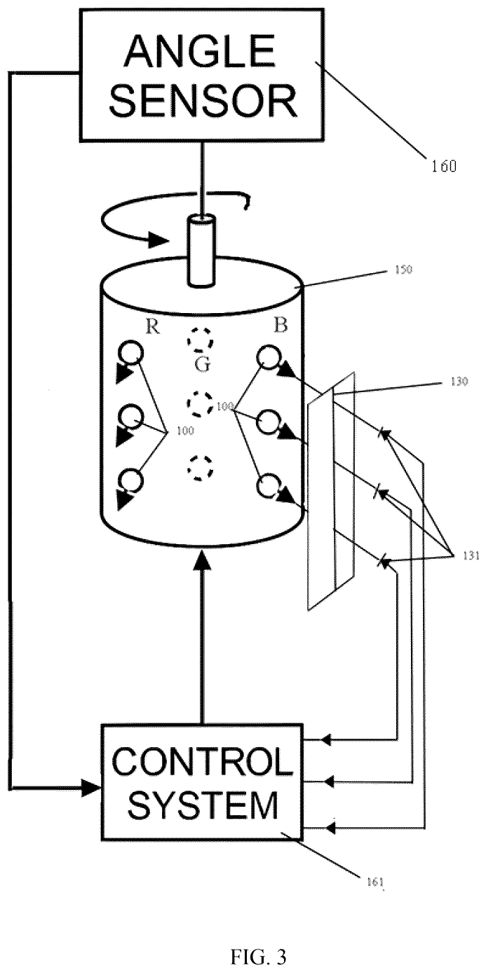

FIG. 3 illustrates an embodiment in which a rotatable cylinder 150 carries multiple laser emitters 100 with beam-forming optics. In some embodiments, each cylinder forms a vertical column of display pixels. In some embodiments, for a given display pixel, red, green, and blue laser emitters are disposed at a common axial position on the cylinder and are angularly spaced about the cylinder. In some embodiments, the angular spacing is approximately 120 degrees.

An angle sensing arrangement may provide a signal indicative of a current angular position of the cylinder. Based on that signal, a controller adjusts laser intensity.

### 6. Vertical Rotating Screen-Element Embodiment

In some embodiments, laser-carrying elements are implemented as vertical rotating screen elements 230 that carry more than one display pixel horizontally. The display may form a volumetric image 240.

### 7. Spherical-Element Embodiment

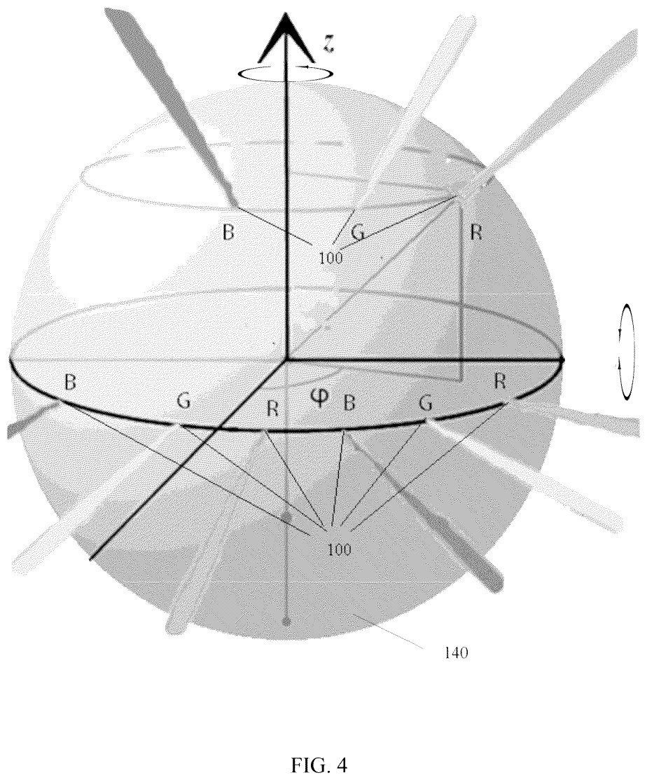

FIG. 4 illustrates a spherical pixel element 140 carrying RGB laser emitters 100 and configured for angular pointing over azimuth and elevation. In some embodiments, spherical elements are arranged across a display surface. In some embodiments, the spherical elements may be arranged in a hexagonal lattice. Each spherical element may carry at least three laser emitters and may be configured to direct emitted light over a wide range of azimuthal and meridional angles to form multiple independent angular views.

### 8. Angle Sensing Subsystem

The angle sensing subsystem may include an angle-of-rotation sensor or encoder associated with a drive or rotating element.

### 9. Individual Emitter Pointing Deviations

In some embodiments, individual laser emitters may exhibit pointing deviations relative to an ideal pointing direction corresponding to a global angle.

### 10. Beam-Direction Detector and Calibration

To compensate for such deviations, the system may include a beam-direction detector positioned outside the operational field of view. A controller may compute timing offsets and/or phase offsets for intensity modulation as a function of angular position based on measurements obtained from the beam-direction detector.

### 11. Synchronized Modulation and Update Step

During operation, the controller may repeatedly read a current angular position, select view data corresponding to that position, and set intensities of the laser emitters accordingly. In some embodiments, the controller updates view data when the current angular position changes by an increment not greater than an azimuthal divergence of the output beam.

### 12. Adaptive Selection of Active Laser Emitters

In some embodiments, when forming a view in a direction different from a direction substantially perpendicular to a plane of the display, the controller selects a subset of active laser emitters as a function of current angular position so as to reduce a number of simultaneously active laser emitters as the angle between the emission direction and the plane of the display increases while maintaining a required resolution.

In some embodiments, the number of active laser emitters is selected such that a spacing between adjacent beams, determined in projection onto a viewing plane, is maintained within a range from 1.0 times a nominal beam spacing at emission substantially perpendicular to the plane of the display to 0.5 times the nominal beam spacing at an angle of 30 degrees between the emission direction and the plane of the display.

In some embodiments, the subset of active laser emitters is selected based on a mapping of current angular position to an activation pattern of laser emitters. In some embodiments, the controller cyclically changes the composition of the subset for different frames and/or scan cycles while maintaining an average number of active laser emitters, thereby equalizing thermal load and emitter aging.

### 13. Modulation Node for Meridional Views

In some embodiments, for each display pixel there is provided a modulation node configured to form multiple meridional views.

### 14. Hemispherical Modulation-Node Embodiment

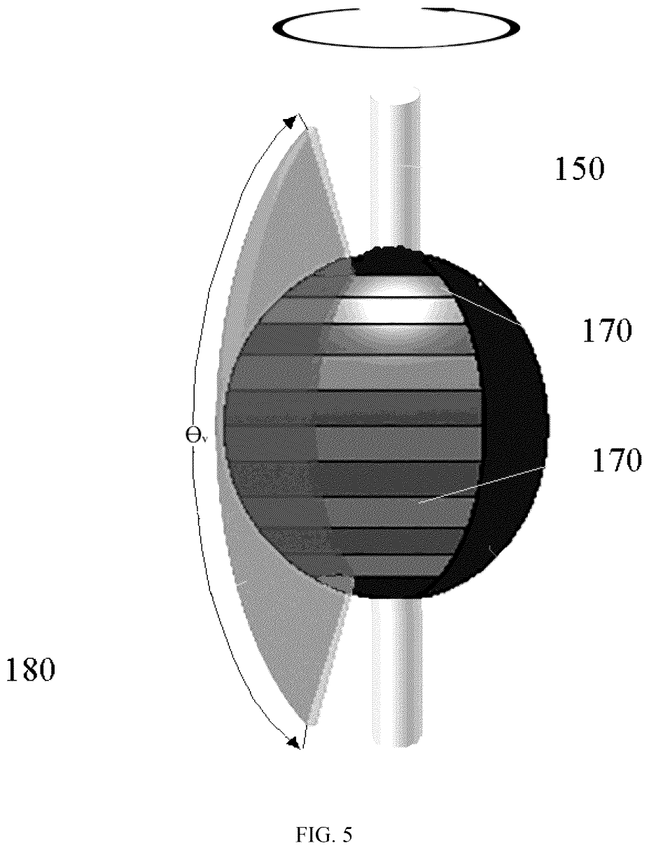

FIG. 5 illustrates an embodiment in which a rotatable cylinder 150 with laser emitters forms a laser beam 180 that passes through a region containing modulators 170 arranged on a hemispherical surface. A portion of the hemispherical surface may be free of modulators.

### 15. Planar Modulation-Node Embodiment

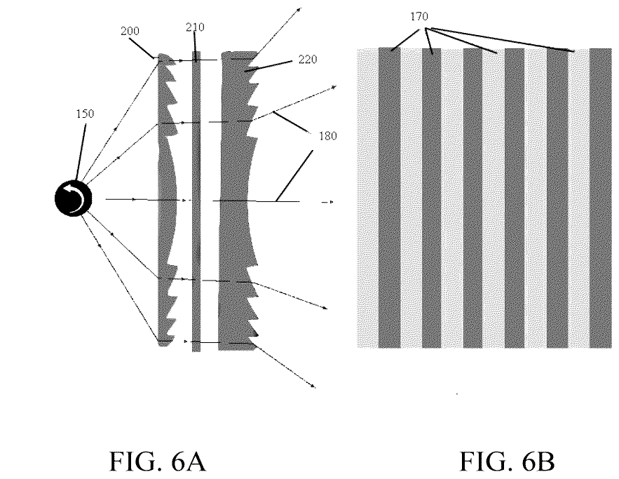

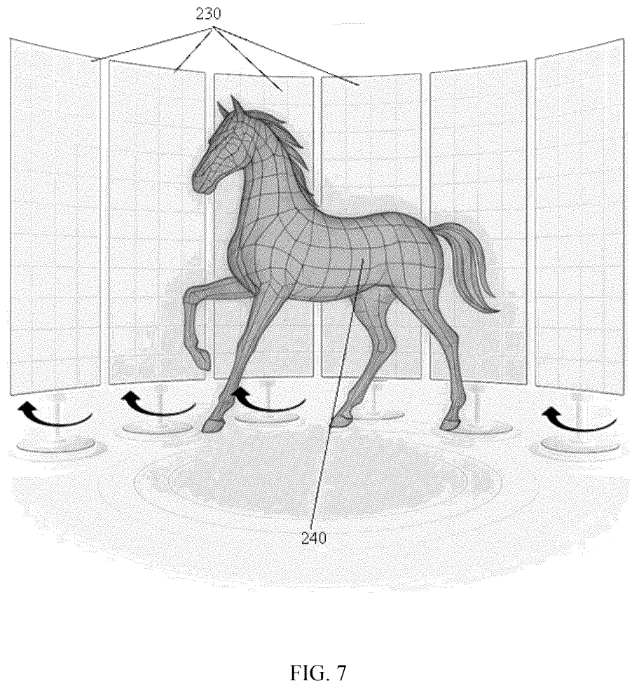

FIG. 6A illustrates an embodiment in which a rotatable cylinder 150 with lasers forms beams 180 at different cylinder rotation angles. The beams pass through a positive optical element 200, then through a planar modulation structure 210 with modulators, and then through a negative optical element 220. FIG. 6B illustrates an arrangement of modulators 170.

### 16. Diffraction Considerations

In some embodiments, a dimension of each addressable region is selected such that diffraction-induced broadening after transmission through the addressable region does not substantially increase a divergence associated with a corresponding view.

### 17. Both-Side Viewing

In some embodiments, an operational field of view includes angular ranges on opposite sides of the display to enable viewing from both sides of the display.

### 18. Variations and Combinations

The disclosed embodiments may be implemented in various combinations. Features described in connection with one embodiment may be used in other embodiments unless inconsistent therewith.

1. A light-field display, comprising:
a plurality of laser emitters arranged as an array of display pixels, wherein at least a portion of the display pixels each includes a red laser emitter, a green laser emitter, and a blue laser emitter;
for each laser emitter, beam-shaping optics positioned to receive output light from the corresponding laser emitter and configured to form a corresponding output beam having a predetermined angular intensity distribution;
an angular scanning subsystem configured to steer the output beams through a plurality of angular positions within an operational field of view to provide a plurality of angular views;
an angle sensing subsystem configured to provide to a controller information indicative of a current angular position of the angular scanning subsystem; and
the controller coupled to the laser emitters and configured to, in synchronism with the information indicative of the current angular position, independently modulate an optical output intensity of each of the laser emitters according to view data corresponding to the current angular position, thereby reconstructing a light field observable from different viewer positions.

2. The display of claim 1, wherein the predetermined angular intensity distribution is characterized by an azimuthal divergence that is smaller than a meridional divergence of the output beam.

3. The display of claim 2, wherein:
the azimuthal divergence is characterized by an FWHM of a far-field angular intensity profile in an azimuthal plane; and
the meridional divergence is characterized by an FWHM of a far-field angular intensity profile in a meridional plane and is sufficient to provide visibility of a display pixel within a defined elevation viewing range.

4. The display of claim 2, wherein the beam-shaping optics comprise at least one lens element configured to broaden the output beam in a meridional direction relative to an azimuthal direction.

5. The display of claim 1, wherein the angular scanning subsystem comprises at least one deflecting element.

6. The display of claim 1, wherein the angular scanning subsystem comprises laser-carrying elements mechanically coupled to a drive and configured to rotate about respective axes to steer the output beams.

7. The display of claim 6, wherein the laser-carrying elements comprise a plurality of cylinders rotatable about respective vertical axes, each cylinder carrying a plurality of the laser emitters and forming a vertical column of display pixels, and wherein, for at least one display pixel, red, green, and blue laser emitters are disposed on the cylinder at a common axial position and are angularly spaced about the cylinder.

8. The display of claim 7, wherein the red, green, and blue laser emitters for the at least one display pixel are angularly spaced by approximately 120 degrees about the cylinder.

9. The display of claim 6, wherein the laser-carrying elements comprise a plurality of spherical elements arranged across a display surface, each spherical element carrying at least three laser emitters and being configured to steer the output beams over a plurality of azimuthal and meridional angles.

10. The display of claim 6, wherein the laser-carrying elements comprise a plurality of vertical rotating screen elements, each carrying more than one display pixel in a horizontal direction.

11. The display of claim 1, wherein the controller is configured to update the view data when the current angular position changes by an angular increment that is not greater than an azimuthal divergence of the output beam defined by an FWHM of a far-field azimuthal intensity profile.

12. The display of claim 1, further comprising, for each display pixel, a modulation node configured to form a plurality of meridional views, the modulation node including an intensity modulator layer having a plurality of independently controllable addressable regions.

13. The display of claim 12, wherein the beam-shaping optics form an output beam that is narrow in an azimuthal plane and broad in a meridional plane such that different meridional components of the output beam pass through different addressable regions and are independently intensity-modulated.

14. The display of claim 12, wherein the modulation node comprises a hemispherical surface carrying modulators.

15. The display of claim 12, wherein the modulation node comprises a planar modulation structure carrying modulators and one or more optical elements configured to provide incidence closer to normal and to restore a target angular distribution after modulation.

16. The display of claim 1, wherein the operational field of view includes a first angular range on a first side of the display and a second angular range on a second side of the display to enable viewing from both sides of the display.

17. The display of claim 1, further comprising a beam-direction detector positioned outside the operational field of view and configured to measure an actual angular direction of at least one output beam during scanning.

18. The display of claim 17, wherein the controller is configured to compute, based on measurements obtained from the beam-direction detector, timing offsets and/or phase offsets for intensity modulation as a function of angular position to compensate angular misalignment.

19. The display of claim 12, wherein each addressable region has a meridional dimension selected such that diffraction-induced broadening after transmission through the addressable region does not substantially increase a meridional divergence associated with a corresponding meridional view.

20. A method of forming a light field with a light-field display, the method comprising:
emitting light with a plurality of laser emitters arranged as an array of display pixels;
forming, for each laser emitter, a corresponding output beam using beam-shaping optics such that the output beam has a predetermined angular intensity distribution;
scanning the output beams through a plurality of azimuthal angular positions within an operational field of view using an angular scanning subsystem;
determining a current azimuthal angular position during scanning using an angle sensing subsystem; and
independently modulating, with a controller and in synchronism with the current azimuthal angular position, an output intensity of the laser emitters according to view data corresponding to the current azimuthal angular position, thereby reconstructing a light field observable from different viewer positions.

21. The method of claim 20, wherein the view data are updated when the current azimuthal angular position changes by an angular increment that is not greater than an azimuthal divergence of the output beam defined by an FWHM of a far-field azimuthal intensity profile.

22. The method of claim 20, further comprising measuring, during scanning, an actual angular direction of at least one output beam using a beam-direction detector positioned outside the operational field of view.

23. The method of claim 22, further comprising computing, based on the measuring, and applying, with a controller, timing offsets and/or phase offsets for intensity modulation as a function of angular position to compensate angular misalignment.

24. The method of claim 20, wherein, when forming a view in a direction different from a direction substantially perpendicular to a plane of the display, the controller selects a subset of active laser emitters as a function of current angular position so as to reduce a number of simultaneously active laser emitters as an angle between the emission direction and the plane of the display increases while maintaining a required resolution.

25. The method of claim 24, wherein the number of active laser emitters is selected such that a spacing between adjacent beams, determined in projection onto a viewing plane, is maintained within a range from 1.0 times a nominal beam spacing at emission substantially perpendicular to the plane of the display to 0.5 times the nominal beam spacing at an angle of 30 degrees between the emission direction and the plane of the display.

26. The method of claim 24, wherein the subset of active laser emitters is selected based on a mapping of current angular position to an activation pattern of laser emitters.

27. The method of claim 24, wherein the controller cyclically changes a composition of the subset of active laser emitters for different frames and/or scan cycles while maintaining an average number of active laser emitters, thereby equalizing thermal load and emitter aging.
